(19) United States
(12) Patent Application Publication
(10) Pub. No.: US 2004/0103875 A1
(43) Pub. Date: Jun. 3, 2004

(54) Method and apparatus for suppressing diesel engine emissions

(76) Inventors: Aaron Joseph Simon, Clifton Park, NY (US); Venkatraman Ananthakrishnan Iyer, Clifton Park, NY (US); Juan Carlos Alvarez, Niskayuna, NY (US); Samar Shaker Soliman, Rexford, NY (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/065,946

(22) Filed: Dec. 3, 2002

(51) Int. Cl. F02B 3/00

(52) U.S. Cl. 123/300; 123/305; 123/431; 123/446

(57) ABSTRACT

A method and apparatus for controlling fuel injection timing in a compression ignition engine is provided. The method includes monitoring a position of a piston reciprocating in a cylinder between a top dead center (TDC) position and a bottom dead center (BDC) position and injecting a predetermined quantity of fuel into the cylinder when the piston is at least one of reciprocating from said TDC toward BDC during an intake stroke and at BDC reciprocating toward TDC during a compression stroke.

### BACKGROUND OF INVENTION

This invention relates generally to fuel control systems for compression ignition engines and, more particularly, to a fuel injection system that suppresses emissions generated by compression ignition diesel engines.

Diesel engine exhaust is a heterogeneous mixture, which contains gaseous emissions such as carbon monoxide (CO), unburned hydrocarbons (HC), and nitrogen oxides (NOx). Additionally, diesel engine exhaust contains particulate matter (PM), also known as soot. Soot is a solid, dry, solid carbonaceous material that makes up one component in total particulate matter (TPM), and contributes to visible emissions that may exhaust through a diesel exhaust. Because diesel engines operate with an excess of combustion air (lean exhaust), such engines generally have emissions of CO and gas phase HCs that are below EPA limits. However, emissions from diesel engines have been under increasing scrutiny in recent years, and standards, especially for particulate emissions, have become stricter.

It is known to facilitate reducing emissions of NOx from diesel engines by retarding injection timing. However, retarding injection timing may cause a corresponding increase in particulate emissions, particularly of the dry carbon or soot portion. Emissions of NOx can also be reduced by applying exhaust gas recirculation (EGR) technology or more advanced direct fuel injection systems, modifying the injection timing, increasing the compression ratio, and/or reducing manifold air temperatures. However, implementing such techniques may also cause a corresponding increase in particulate emissions, and/or cause fuel consumption penalties.

### SUMMARY OF INVENTION

In one aspect, a method of controlling fuel injection timing in a compression ignition engine is provided. The method includes monitoring a position of a piston reciprocating in a cylinder between a top dead center (TDC) position and a bottom dead center (BDC) position and injecting a pre-determined quantity of fuel into the cylinder when the piston is at least one of reciprocating from the TDC toward BDC during an intake stroke and at BDC reciprocating toward TDC during a compression stroke.

In another aspect, a compression ignition engine is described. The engine includes an engine block including at least one cylinder, at least one cylinder head covering the at least one cylinder, a piston reciprocating in the each cylinder between a top dead center (TDC) position and a bottom dead center (BDC) position, a combustion air inlet plenum in flow communication with the at least one cylinder, and a fuel injection system including at least one fuel injector, the system configured to inject fuel into the at least one cylinder when each piston is at least one of reciprocating from TDC toward BDC during an intake stroke and at BDC reciprocating toward TDC during a compression stroke.

In yet another aspect, a railroad locomotive is described. The locomotive includes a compression ignition engine including an engine block including at least ten cylinders, at least one cylinder head covering the cylinders, a piston reciprocating in each cylinder between a top dead center (TDC) position and a bottom dead center (BDC) position, a combustion air inlet plenum in flow communication with each cylinder, and a fuel injection system including at least one fuel injector, the system configured to inject fuel into each cylinder when the piston is at least one of reciprocating from the TDC toward BDC during an intake stroke and at BDC reciprocating toward TDC during a compression stroke.

In still another aspect, a railroad locomotive is described. The locomotive includes a compression ignition engine including a compression ignition engine including an engine block including at least ten cylinders, at least one cylinder head covering the cylinders, a piston reciprocating in each cylinder between a top dead center (TDC) position and a bottom dead center (BDC) position, a combustion air inlet plenum in flow communication with the cylinder, and a fuel injection system that includes at least one fuel injector mounted in the at least one cylinder head, the fuel injector includes a nozzle that is at least partially within the cylinder, the system configured to inject the fuel at a first pre-determined piston position that corresponds to a crank angle of between about negative three hundred sixty degrees and about zero degrees., and inject a second quantity of fuel into the cylinder at a second pre-determined piston position that corresponds to a crank angle of between about negative forty five degrees and about twenty degrees, such that a fuel/air equivalence ratio of the fuel/air mixture in each cylinder at ignition is between 0.10 and 0.85.

In yet another aspect, a railroad locomotive is described. The locomotive includes a compression ignition engine including an engine block including at least ten cylinders, at least one cylinder head covering the cylinders, a piston reciprocating in each cylinder between a top dead center (TDC) position and a bottom dead center (BDC) position, a combustion air inlet plenum in flow communication with each cylinder, and a fuel injection system including at least one fuel injector mounted in the combustion air inlet plenum, the fuel injector including a nozzle, the nozzle at least partially within the combustion air inlet plenum, the system configured to inject fuel into the cylinders at a crank angle of between about negative three hundred sixty degrees and about three hundred sixty degrees, such that a fuel/air equivalence ratio of a fuel/air mixture in the cylinder at ignition is between 0.10 and 0.85.

### BRIEF DESCRIPTION OF DRAWINGS

FIG. 1 is a front-side isometric view of a compression ignition diesel engine.

FIG. 2 is a simplified cross sectional view of a portion of a four-stroke cycle diesel engine with manifold fumigation.

FIG. 3 is a cross sectional view of a portion of an alternative embodiment of a four-stroke cycle, medium speed diesel engine with in-cylinder premixing.

FIG. 4 is a cross sectional view of a portion of the engine shown in FIG. 3 at the end of a compression stroke wherein a premixed charge is ignited by a pilot spray.

FIG. 5 is a graph illustrating exemplary emissions levels as a function of air-fuel ratio in the exemplary internal combustion engine.

### DETAILED DESCRIPTION

The basic combustion process for diesel engines involves a diffusion-type combustion of liquid fuel. More specifically, as liquid fuel is injected into compressed hot cylinder air, the fuel evaporates and mixes with the surrounding air to form a flammable mixture. This is a continuing process that happens over time as the fuel is injected into the cylinder. The mixture formed initially will combust and raise the local temperature before the later evaporated fuel has time to fully mix with air. As a result, the later burned fuel is subjected to high temperatures with insufficient air and under such conditions, high temperature pyrolysis of fuel may occur, thus forming soot. As the combustion proceeds in the cylinders, a substantial portion of the soot may be burned-up as a result of exposure to air in the cylinder. The soot will continue to be burned up in the engine until the power stroke volume expansion sufficiently lowers the cylinder temperature, at which time the chemical reaction is stopped, and any non-combusted soot remaining in the cylinder is discharged from the engine as smoke or particulate emission when the exhaust valve is opened.

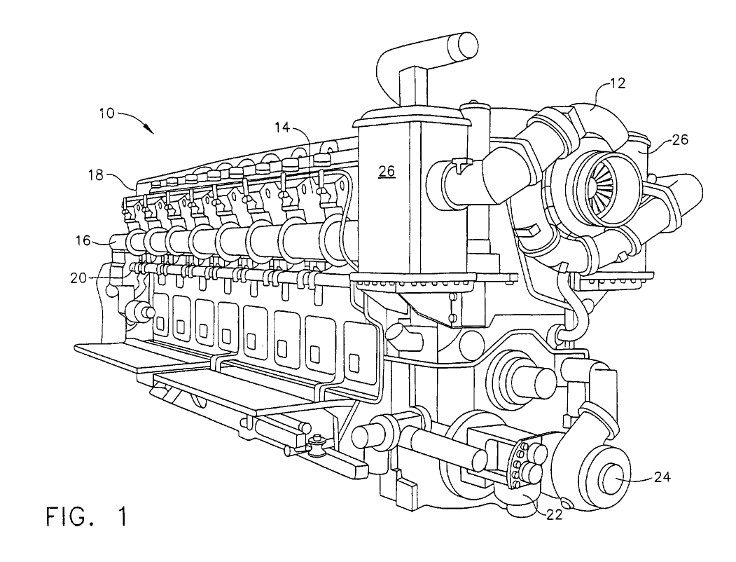

FIG. 1 is a front-side isometric view of a compression ignition diesel engine 10 and includes a turbo charger 12 and a plurality of power cylinders 14. For example, a twelve-cylinder engine 10 has twelve power cylinders 14 while a sixteen-cylinder engine 10 has sixteen power cylinders 14. Engine 10 also includes an air intake manifold 16, a fuel supply line 18 for supplying fuel to each power cylinder 14, a water inlet manifold 20 used in cooling engine 10, a lube oil pump 22 and a water pump 24. An intercooler 26 connected to turbo charger 12 facilitates cooling turbo-charged air before it enters respective power cylinder 14. In an alternative embodiment, engine 10 is a Vee-type engine, wherein power cylinders 14 are arranged in an offset angle from adjacent power cylinders 14.

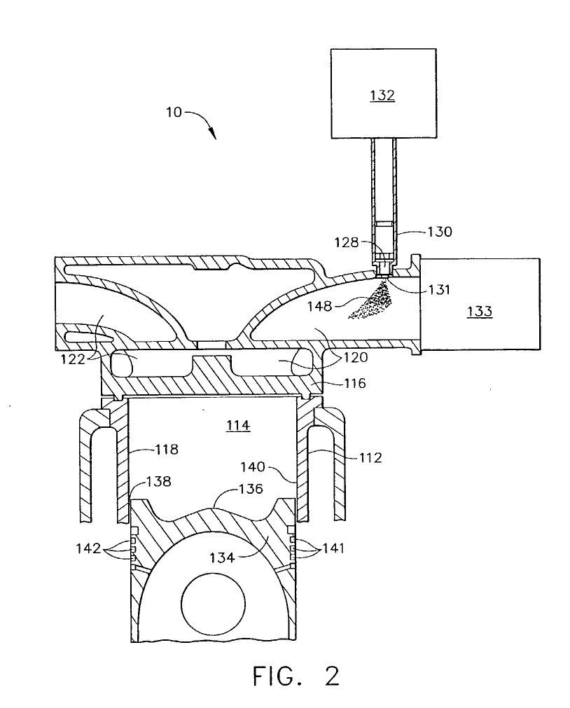

FIG. 2 is a cross sectional view of a portion of a four-stroke cycle, medium speed diesel engine 10 with manifold fumigation. In one embodiment, engine 10 is a locomotive engine. Engine 10 includes an engine block 112 that defines a cylinder 114 including a cylinder head 116 and a circumferential wall surface or liner 118. A combustion air intake port 120 and an exhaust gas port 122 communicate through cylinder head 116 with cylinder 114. Air intake port 120 is in flow communication with cylinder 114 through an intake valve (not shown) and exhaust gas port 122 is in flow communication with cylinder 114 through an exhaust valve (not shown). Air intake port 120 includes at least one fuel injection port 128 communicating with a fuel injector 130 including an injector nozzle 131. In an alternative embodiment, additional fuel injectors 130 are provided to facilitate achieving a homogeneous gas-phase mixture of combustion air and fuel. Fuel injector 130 is in communication with a fuel supply system 132 that includes a subsystem configured to regulate a temperature of the fuel to facilitate achieving an optimal vaporization. Air intake port 120 is in communication with an air supply system 133 that includes a sub-system configured to regulate a temperature of the combustion air to facilitate achieving an optimal gas-phase mixing.

While the present invention is described in the context of a locomotive, it is recognized that the benefits of the invention accrue to other applications of diesel engines. Therefore, this embodiment of the invention is intended solely for illustrative and exemplary purposes and is in no way intended to limit the scope of application of the invention.

A piston 134 is slidingly disposed in cylinder 114 and includes a face 136 that is adjacent cylinder head 116, and a circumferential sidewall surface 138 that is spaced from cylinder 114 by a predetermined clearance gap 140. Piston 134 includes a plurality of closely spaced, annular grooves 141, each of which is configured to receive an annular, split, compression ring seal 142 for establishing a compression seal between piston sidewall surface 138 and cylinder liner 118. Piston 134 is shown in a bottom-dead-center (BDC) stroke position, in which piston face 136 and cylinder head 116 are at their furthest relative distance. Piston 134 reciprocates inside cylinder 114 between BDC and a top-dead-center (TDC) stroke position in which piston face 136 and cylinder head 116 are at their closest relative distance. Thus, cylinder 114 has a maximum working volume above piston face 136 when piston 134 is at BDC, and a minimum working volume above piston face 136 when piston is at TDC. The ratio of the BDC volume to the TDC volume is known as the compression ratio of cylinder 114.

In operation, piston 134 reciprocates between TDC and BDC positions. More specifically, the movement of piston 134 from TDC to BDC is referred to as a downstroke and the movement of piston 134 from BDC to TDC is referred to as an upstroke. Starting from a position wherein piston 134 is at TDC, during or after a firing of fuel in cylinder 114 from a previous cycle, a first downstroke or power stroke occurs after combustion when piston 134 is driven away from cylinder head 116 by a force of rapidly expanding combustion gases. The force acting on piston 134 is transmitted to connecting parts (not shown) to deliver power to drive an engine shaft (not shown). For reference, a piston position at TDC during firing is known as a crank angle of zero degrees. After piston 134 reaches BDC, or a crank angle of one-hundred eighty degrees, the next stroke of the cycle begins. A first upstroke or exhaust stroke expels depleted exhaust gases from cylinder 114. As piston 134 moves toward cylinder head 116, the volume of cylinder 114 decreases, causing the exhaust gas pressure in cylinder 114 in increase. On the exhaust stroke, the exhaust valve opens to allow the increasingly pressurized exhaust gas to escape cylinder 114. After piston 134 reaches TDC, or a crank angle of three hundred sixty degrees, a second down stroke or, intake stroke occurs, and the air inlet valve is open and injector 130 is pressurized by fuel supply system 132. Because of the cyclic nature of the strokes referred to, a crank angle of three hundred sixty degrees and negative three hundred sixty degrees are equivalent. Combustion air at a regulated predetermined temperature and at a regulated predetermined pressure passes injector nozzle 131 as it is forced into cylinder 114. Injector 130 releases a pressurized stream 148 of fuel through nozzle 131 into the combustion air stream in inlet 120. In one embodiment, stream 148 is released at a crank angle of between about negative three hundred sixty degrees and three hundred sixty degrees. Nozzle 131 is configured to atomize the fuel passing therethrough. The warmed and atomized fuel vaporizes in inlet 120 and mixes homogeneously with the combustion air prior to entering cylinder 114. By the time piston 134 reaches BDC, cylinder 114 is substantially filled with a homogeneous fuel/air mixture.

At BDC or a crank angle of negative one hundred eighty degrees, piston 134 reverses travel and begins a first upstroke or compression stroke. As piston 134 moves closer to cylinder head 116, the volume of cylinder 114 decreases, causing the temperature and pressure of the homogeneous fuel/air mixture to increase to an ignition point wherein combustion takes place. Combustion takes place near TDC or a crank angle of zero degrees, and is controlled by varying a fuel/air mixture and engine operating parameters to occur at an optimum point in the stroke. In one embodiment, the fuel/air mixture and engine operating parameters are controlled by, for example, exhaust gas recirculation (EGR), water injection directly into the cylinder, water injection into the intake manifold, variable valve timing, variable compression ratio, and/or variable geometry turbomachinery to optimize the cylinder pre-compression conditions. This is in contrast to at least some known combustion processes wherein liquid fuel is injected into the cylinder near the top of the compression stroke. Injecting fuel into inlet 120 and modulating the fuel and air to achieve a homogeneous mixture at the end of the intake stroke changes the combustion mode from a diffusion flame to a lean-mixed combustion event.

The traditional direct-injection system referred to above generates a mixing-controlled burn during the heat release process in the diesel engine cycle. The fuel and air burn at a stoichiometric ratio of approximately one, in localized areas at a flame front, although the overall mixture in cylinder 114 is lean. This results in high temperatures at the flame front of the combustion event, which causes high levels of NOx emissions. Also due to the heterogeneous nature of the diffusion flame, there are fuel rich regions that may burn with insufficient oxygen, thus producing large quantities of soot and particulate matter. In contrast, the fuel and air are uniformly mixed within the present invention such that the entire mixture is at an overall lean equivalence ratio. This process facilitates eliminating the formation of soot and also results in low NOx emissions due to the low flame temperatures and because there is no locally rich zone of combustion and rather, ignition occurs substantially spontaneously and concurrently at many points in cylinder 114.

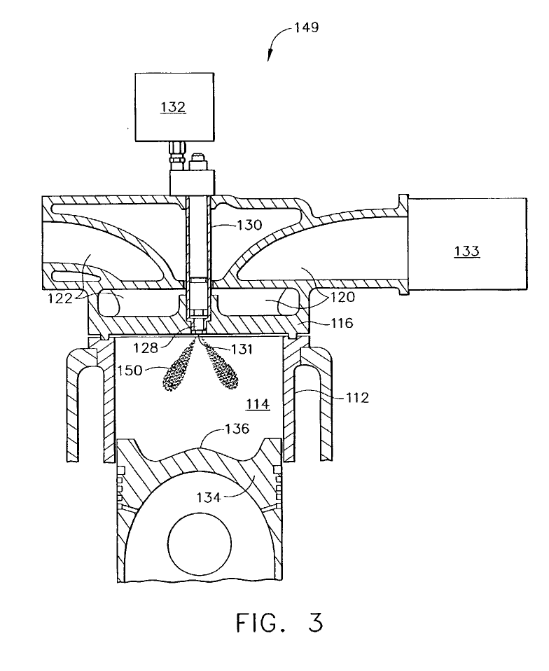

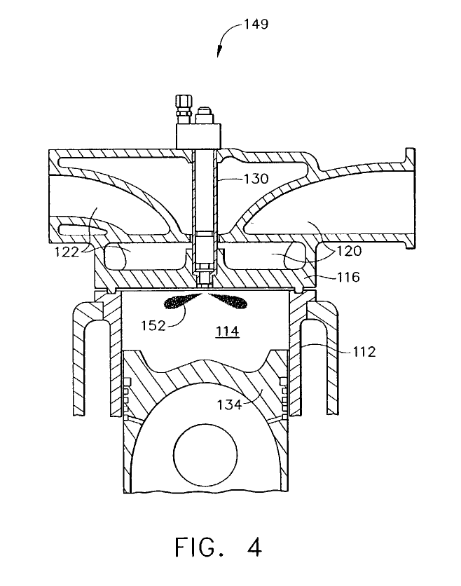

FIG. 3 is a cross sectional view of a portion of an alternative embodiment of a four-stroke cycle, medium speed diesel engine 149 with in-cylinder premixing. FIG. 4 is a cross sectional view of a portion of the engine shown in FIG. 3 at the end of a compression stroke wherein a premixed charge is ignited by a pilot spray. Engine 149 is substantially similar to Engine 10 shown in FIGS. 1 and 2 and components in engine 149 that are identical to components of engine 10 are identified in FIG. 3 using the same reference numerals used in FIG. 2. Accordingly, engine 149 includes an engine block 112 that defines a cylinder 114 including a cylinder head 116 and a circumferential wall surface or liner 118. A combustion air intake port 120 and an exhaust gas port 122 communicate through cylinder head 116 with cylinder 114. Air intake port 120 is in flow communication with cylinder 114 through an intake valve (not shown) and exhaust gas port 122 is in flow communication with cylinder 114 through an exhaust valve (not shown). Cylinder head 116 includes at least one fuel injection port 128 communicating with a fuel injector 130 including an injector nozzle 131.

In operation, piston 134 reciprocates between TDC and BDC positions. Starting from a position wherein piston 134 is at TDC at a crank angle of negative three hundred sixty degrees, an intake stroke occurs and the air inlet valve is open. Combustion air at a regulated predetermined temperature and at a regulated predetermined pressure passes inlet 120 as it is forced into cylinder 114. When piston 134 reaches BDC or a crank angle of negative one hundred eighty degrees, cylinder 114 is substantially filled with combustion air. At BDC, piston 134 reverses travel and begins a compression stroke and the air inlet valve is closed. Injector 130 releases a first, main pressurized stream 150 of fuel through nozzle 131 into cylinder 114. In one embodiment, stream 150 is released at a crank angle of between approximately negative three hundred sixty degrees and approximately zero degrees. First pressurized stream 150 contains all or a portion of the fuel that will be injected during that cycle. Nozzle 131 is configured to atomize the fuel passing through it. The warmed and atomized fuel vaporizes in cylinder 114 and mixes homogeneously with the combustion air in cylinder 114. During the compression stroke, as piston 134 moves closer to cylinder head 116, the volume of cylinder 14 decreases, causing the temperature and pressure of the combustion air/fuel mixture to increase. Injector 130 releases a second pressurized stream 152 (see FIG. 4) of fuel through nozzle 131 into cylinder 114. In one embodiment, stream 150 is released at a crank angle between approximately negative forty five degrees and approximately twenty degrees. The second stream 152 of fuel contains the remaining fuel that will be injected during that stroke. The injection of the second, pilot stream 152 of fuel ignites the homogenous air/fuel mixture in cylinder 114. Combustion takes place near TDC and is controlled to occur at an optimum point in the stroke. The combustion process is controlled by regulating the temperature of the fuel, the temperature of the combustion air, the timing and duration of the main injection stream and the timing and duration of the pilot injection stream.

With a dual injection strategy, a portion of, or all of, the fuel is injected early in the engine cycle, during the intake stroke and at the beginning of the compression stroke. This allows enough time for the fuel and the in-cylinder gas to mix before ignition. A homogeneous mixture is created in this process and this mixture is ignited by injecting a portion of the fuel near TDC. The pilot injection will trigger combustion throughout the homogeneous fuel-air mixture. In an alternative embodiment, the homogeneous mixture auto-ignites without the use of a pilot stream. In the exemplary embodiment, the early fuel injection is achieved by a cam-driven fuel injector system. In an alternative embodiment, the fuel injection system uses an advanced injection technology such as, a common-rail fuel system or advanced unit pump and unit injectors. Additionally, combustion is controlled using supplemental injection of inert media such as, for example, exhaust gas, water or additional air.

The dual injection strategy allows engine 149 to operate in a different combustion mode compared to a direct injection engine. The combustion strategy is changed from a diffusion flame to a lean-premixed or partially pre-mixed combustion event. In this embodiment, a portion of, or all of, the fuel used in the cycle is uniformly mixed with the in-cylinder air so that the majority of the mixture is at a lean equivalence ratio at the time of combustion. This process facilitates eliminating the formation of soot and also results in low NOx emissions due to the low flame temperatures.

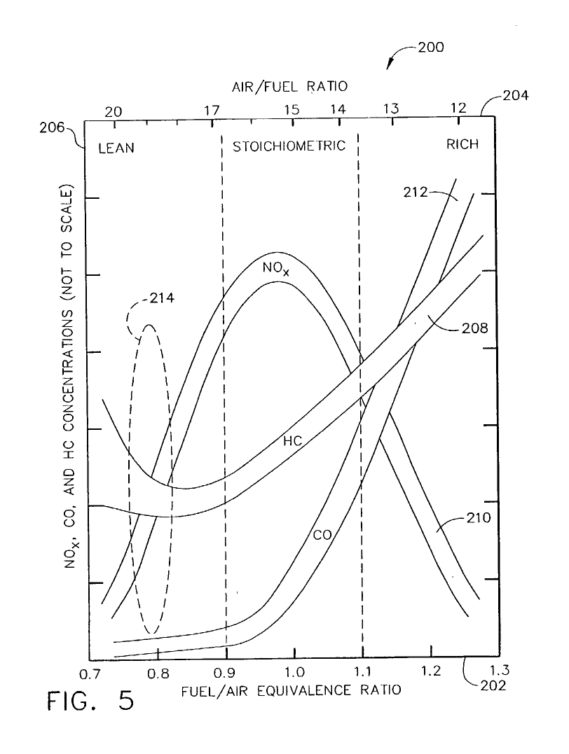

FIG. 5 is a graph illustrating exemplary emissions levels as a function of air-fuel ratio in an exemplary internal combustion engine 10. A horizontal axis of graph 200 represents a fuel/air equivalence ratio scale 202 with a corresponding air/fuel ratio scale 204. The fuel/air equivalence ratio is defined as the actual fuel-to-air mass ratio divided by the stoichiometric fuel-to-air mass ratio. A fuel/air equivalence ratio that is stoichiometric if the fuel/air equivalence ratio is greater in value than 0.9 and less in value than 1.1. A lean fuel/air mixture has a fuel/air equivalence ratio of less than 0.9. A rich fuel/air mixture has a fuel/air equivalence ratio of greater than 1.1.

A vertical axis 206 of graph 200 represents concentrations of constituents of internal combustion engine exhaust. A band 208 shows the range of a concentration of hydrocarbon emissions that is emitted by an internal combustion engine operating at fuel/air equivalence ratios shown on axis 202. Likewise, a band 210 shows the range of a concentration of NOx emissions that is emitted by an internal combustion engine operating at fuel/air equivalence ratios shown on axis 202 and band 212 shows the range of a concentration of carbon monoxide emissions that is emitted by an internal combustion engine operating at fuel/air equivalence ratios shown on axis 202.

As discussed above, the basic combustion process for direct injection diesel engines involves a diffusion-type combustion of liquid fuel. The mixture formed initially after the fuel is injected into the cylinder will combust and raise the local temperature before the later evaporated fuel has time to fully mix with air. The result is areas of rich mixture combustion, stoichiometric mixture combustion, and lean mixture combustion occurring in the cylinder at the same time. Even though the overall mixture is held to a lean fuel/air equivalence ratio, localized areas of rich mixture combustion and stoichiometric mixture combustion raise outlet emissions levels of NOx, HC and CO unacceptably. By comparison, operation with a lean homogeneous mixture produces less emissions of NOx, HC and CO. Engine 10 and engine 149 may operate in area 214 with a fuel/air equivalence ratio of less than 0.85 homogeneous throughout cylinder 114 at the time of ignition. A fuel/air equivalence ratio of less than approximately 0.85 that is homogeneous throughout cylinder 114 at the time of ignition ensures lower NOx, HC and CO generation and subsequent emissions. Operation of engines 10 and 149 at a fuel/air equivalence ratio of less than approximately 0.75 is governed by fuel economy and combustion stability considerations. In the exemplary embodiment, engines 10 and 149 operate at a fuel/air equivalence ratio of between about 0.10 to about 1.00. In an alternate embodiment, engines 10 and 149 operate at a fuel/air equivalence ratio of between about 0.20 to about 0.60. In an another alternate embodiment, engines 10 and 149 operate at a fuel/air equivalence ratio of between about 0.75 to about 0.85.

The above-described diesel engine fuel injection systems are cost-effective and highly reliable. Each system includes an injector that injects fuel into a diesel engine combustion air volume such that a homogeneous fuel/air mixture results early in the engine cycle. Such injection facilitates complete burning of the fuel at lower temperatures resulting in less particulate emissions being formed and less NOx being generated. As a result, the fuel injection system facilitates reducing engine emissions in a cost-effective and reliable manner.

Exemplary embodiments of diesel engine fuel injection systems are described above in detail. The systems are not limited to the specific embodiments described herein, but rather, components of each system may be utilized independently and separately from other components described herein. Each diesel engine fuel injection systems component can also be used in combination with other diesel engine fuel injection systems components.

While the invention has been described in terms of various specific embodiments, those skilled in the art will recognize that the invention can be practiced with modification within the spirit and scope of the claims.

1. A method of controlling fuel injection timing in a compression ignition engine including an engine block having at least one cylinder, said method comprising:
monitoring a position of a piston reciprocating in each cylinder between a top dead center (TDC) position and a bottom dead center (BDC) position; and
injecting a pre-determined quantity of fuel into each cylinder when the piston is at least one of reciprocating from said TDC toward BDC during an intake stroke, and at BDC reciprocating toward TDC during a compression stroke.

2. A method in accordance with claim 1 wherein injecting a pre-determined quantity of fuel comprises injecting liquid diesel fuel.

3. A method in accordance with claim 1 further comprising:
regulating a temperature of the fuel supplied to the at least one injector; and
regulating a pressure of the fuel supplied to the at least one injector.

4. A method in accordance with claim 1 further comprising:
regulating a temperature of a supply of combustion air; and
regulating a pressure of a supply of combustion air.

5. A method in accordance with claim 1 wherein controlling fuel injection timing further comprises controlling fuel injection timing of a railroad diesel locomotive engine.

6. A method in accordance with claim 1 wherein at least one fuel injector is mounted in at least one cylinder head covering each cylinder, said method further comprising:
injecting a first pre-determined quantity of fuel into each cylinder at a crank angle of between about negative three hundred sixty degrees and about zero degrees; and
injecting a second pre-determined quantity of fuel into each cylinder at a crank angle of between about negative forty five degrees and about twenty degrees.

7. A method in accordance with claim 1 wherein said engine includes at least one fuel injector mounted in a combustion air inlet plenum, in flow communication with each cylinder, the fuel injector includes a nozzle, the nozzle at least partially within the combustion air inlet plenum, said method further comprising injecting a pre-determined quantity of fuel into each cylinder at a crank angle of between about negative three hundred sixty degrees and about three hundred sixty degrees.

8. A method in accordance with claim 1 wherein injecting a pre-determined quantity of fuel further comprises injecting a quantity of fuel into each cylinder such that the fuel/air equivalence ratio of the fuel/air ratio in each cylinder at ignition is between, approximately 0.10 and 1.00.

9. A method in accordance with claim 8 wherein injecting a quantity of fuel into each cylinder further comprises injecting a quantity of fuel into each cylinder such that the fuel/air equivalence ratio of the fuel/air ratio in each cylinder at ignition is between, approximately 0.20 and 0.60.

10. A method in accordance with claim 8 wherein injecting a quantity of fuel into each cylinder further comprises injecting a quantity of fuel into each cylinder such that the fuel/air equivalence ratio of the fuel/air ratio in each cylinder at ignition is between, approximately 0.75 and 0.85.

11. A method in accordance with claim 1 wherein injecting a pre-determined quantity of fuel comprises injecting a pre-determined quantity of fuel into each cylinder using a common rail fuel injection system.

12. A method in accordance with claim 1 wherein injecting a pre-determined quantity of fuel comprises injecting a pre-determined quantity of fuel into each cylinder using an unit pump and unit injectors fuel injection system.

13. A compression ignition engine comprising:
an engine block comprising at least one cylinder;
at least one cylinder head covering said at least one cylinder;
a piston reciprocating in said at least one cylinder between a top dead center (TDC) position and a bottom dead center (BDC) position;
a combustion air inlet plenum in flow communication with said at least one cylinder; and
a fuel injection system comprising at least one fuel injector, said system configured to inject fuel into said at least one cylinder when said piston is at least one of reciprocating from said TDC toward BDC during an intake stroke and at BDC reciprocating toward TDC during a compression stroke.

14. An engine in accordance with claim 13 wherein said fuel is liquid diesel fuel.

15. An engine in accordance with claim 13 wherein said engine comprises a railroad diesel locomotive engine.

16. An engine in accordance with claim 13 wherein said engine comprises sixteen cylinders.

17. An engine in accordance with claim 13 wherein said engine comprises twelve cylinders.

18. An engine in accordance with claim 13 wherein said fuel injection system is configured to supply a regulated quantity of temperature regulated, pressure regulated fuel to at least one fuel injector.

19. An engine in accordance with claim 13 that further comprises at least one fuel injector mounted in said at least one cylinder head, said at least one fuel injector comprises a nozzle, said nozzle at least partially within its respective cylinder, said fuel injection system configured to inject a first quantity of fuel into each cylinder at a first pre-determined position of it's respective piston in said engine cycle and inject a second quantity of fuel into said cylinder at a second pre-determined piston position in said engine cycle, said second pre-determined position of it's respective piston occurring later in said cycle than said first pre-determined piston position.

20. An engine in accordance with claim 19 wherein the first pre-determined piston position in said engine cycle corresponds to a crank angle of between about negative three hundred sixty degrees and about zero degrees.

21. An engine in accordance with claim 19 wherein the second pre-determined piston position in said engine cycle corresponds to a crank angle of between about negative forty five degrees and about twenty degrees.

22. An engine in accordance with claim 13 wherein said fuel injection system is configured to inject a quantity of fuel into each said cylinder such that the fuel/air equivalence ratio of the fuel/air mixture in said cylinder at ignition is between about 0.10 and about 1.00.

23. An engine in accordance with claim 22 wherein said fuel injection system is configured to inject a quantity of fuel into each said cylinder such that the fuel/air equivalence ratio of the fuel/air mixture in said cylinder at ignition is between about 0.20 and 0.60.

24. An engine in accordance with claim 22 wherein said fuel injection system is configured to inject a quantity of fuel into each said cylinder such that the fuel/air equivalence ratio of the fuel/air mixture in said cylinder at ignition is between about 0.75 and 0.85.

25. An engine in accordance with claim 13 that further comprises at least one fuel injector mounted in said combustion air inlet plenum, said at least one fuel injector comprises a nozzle, said nozzle at least partially within said combustion air inlet plenum, said fuel injection system configured to inject a pre-determined quantity of fuel into each cylinder at a pre-determined piston position in said engine cycle.

26. An engine in accordance with claim 25 wherein said pre-determined piston position in said engine cycle corresponds to a crank angle of between about negative three hundred sixty degrees and about three hundred sixty degrees.

27. A railroad locomotive comprising:
a compression ignition engine comprising an engine block comprising at least ten cylinders;
at least one cylinder head covering said cylinders;
a piston reciprocating in each said cylinder between a top dead center (TDC) position and a bottom dead center (BDC) position;
a combustion air inlet plenum in flow communication with said cylinder; and
a fuel injection system comprising at least one fuel injector, said system configured to inject fuel into said cylinders at a crank angle of between about negative three hundred sixty degrees and about three hundred sixty degrees.

28. A locomotive in accordance with claim 27 wherein said fuel injection system comprises at least one fuel injector mounted in said cylinder head, said fuel injector comprises a nozzle that is at least partially within said cylinder, said system is configured to inject said fuel at a first pre-determined piston position in said engine cycle and inject a second quantity of fuel into said cylinder at a second pre-determined piston position in said engine cycle, said second pre-determined piston position occurring later in said cycle than said first pre-determined piston position.

29. A locomotive in accordance with claim 28 wherein the first pre-determined piston position in said engine cycle corresponds to a crank angle of between about negative three hundred sixty degrees and about zero degrees.

30. A locomotive in accordance with claim 28 wherein the second pre-determined piston position in said engine cycle corresponds to a crank angle of between about negative forty five degrees and about twenty degrees.

31. A locomotive in accordance with claim 27 wherein said fuel injection system is configured to inject a quantity of fuel into said cylinder such that the fuel/air equivalence ratio of the fuel/air mixture in said cylinder at ignition is between 0.10 and 0.85.

32. A locomotive in accordance with claim 27 that further comprises at least one fuel injector mounted in said combustion air inlet plenum, said fuel injector comprises a nozzle, said nozzle at least partially within said combustion air inlet plenum, said fuel injection system configured to inject a pre-determined quantity of fuel into said cylinder at a pre-determined piston position in said engine cycle.

33. A locomotive in accordance with claim 32 wherein said pre-determined piston position in said engine cycle corresponds to a crank angle of between about negative three hundred sixty degrees and about three hundred sixty degrees.

34. A railroad locomotive comprising:
a compression ignition engine comprising an engine block comprising at least ten cylinders;
at least one cylinder head covering said cylinders;
a piston reciprocating in each said cylinder between a top dead center (TDC) position and a bottom dead center (BDC) position;
a combustion air inlet plenum in flow communication with said cylinder; and
a fuel injection system that comprises at least one fuel injector mounted in said at least one cylinder head, said fuel injector comprises a nozzle that is at least partially within said cylinder, said system configured to inject said fuel at a first pre-determined piston position that corresponds to a crank angle of between about negative three hundred sixty degrees and about zero degrees., and inject a second quantity of fuel into said cylinder at a second pre-determined piston position that corresponds to a crank angle of between about negative forty five degrees and about twenty degrees, such that a fuel/air equivalence ratio of the fuel/air mixture in each said cylinder at ignition is between 0.10 and 0.85.

35. A railroad locomotive comprising:
a compression ignition engine comprising an engine block comprising at least ten cylinders;
at least one cylinder head covering said cylinders;
a piston reciprocating in each said cylinder between a top dead center (TDC) position and a bottom dead center (BDC) position;
a combustion air inlet plenum in flow communication with each said cylinder; and
a fuel injection system comprising at least one fuel injector mounted in said combustion air inlet plenum, said fuel injector comprising a nozzle, said nozzle at least partially within said combustion air inlet plenum, said system configured to inject fuel into said cylinders at a crank angle of between about negative three hundred sixty degrees and about three hundred sixty degrees, such that a fuel/air equivalence ratio of a fuel/air mixture in said cylinder at ignition is between 0.10 and 0.85.
